(19) United States
(12) Patent Application Publication
(10) Pub. No.: US 2005/0235735 A1
(43) Pub. Date: Oct. 27, 2005

(54) Micro-structured gas sensor with control of gas sensitive properties by application of an electric field

(76) Inventors: Theodor Doll, Alzey (DE); Harald Botner, Freiburg (DE); Jurgen Wollenstein, Freiburg (DE); Martin Jagle, Sexau (DE); Mirko Lehmann, Freiburg (DE)

Correspondence Address: Patrick J O'Shea;O'Shea Getz & Kosakowski, Suite 912, 1500 Main Street, Springfield, MA, 01115, US

(21) Appl. No.: 10/507,054

(22) PCT Filed: Mar. 12, 2003
(86) PCT No.: PCT/EP03/02544

§ 371 Date: Jun. 13, 2005

(30) Foreign Application Priority Data
Mar. 12, 2002 (DE) 102 10 819.6

(51) Int. Cl. G01N 27/04

(52) U.S. Cl. 73/31.06

(57) ABSTRACT

A gas sensor includes a semiconductor substrate on which is disposed at least one field electrode, and advantageously a plurality of field electrodes. The field electrodes are disposed under a gas-sensitive semiconductor resistive film, with an insulator layer in between. The film, which may be in electrical contact with a pair of external electrodes, may comprise a metal oxide, such as for example SnO₂, WO₃, In₂O₃, Ga₂O₃, Cr₂₋ₓTiₓO_{3+z}, or various organic semiconductors. The field electrodes produce an electric field acting on the semiconductor, and an electroadsorptive effect may occur when the thickness of the gas-sensitive film is on the order of the Debye length. In the case of the known gas-sensitive material SnO₂, for example, the Debye length may be approximately 60 to 80 nm. An electric field produced in the body of the gas sensor may be effective up to the surface of the gas-sensitive film that is exposed to the gas, i.e., the films lying above the gate electrode do not screen the electric field. The use of a plurality of field electrodes may make it possible to offset or control the gradient in the surface potential variation.

### PRIORITY INFORMATION

This application claims priority from German application 102 10 819.6, filed Mar. 12, 2002 and International application PCT/EP03/02544 filed Mar. 12, 2003.

### BACKGROUND OF THE INVENTION

The invention relates in general to gas sensors and in particular to a microstructured gas sensor having gas sensitive properties that are controlled by application of an electric field.

Microstructured gas sensors are disclosed for example in German published patent applications DE 44 42 396 A1 and DE 195 44 303 A1. In recent years, resistance-type gas sensors have been increasingly used to measure air pollutant concentrations in the ppm and ppb ranges. Advantages of such semiconductor gas sensors include relatively low manufacturing cost along with the simplicity of hybrid integration into electronics for the conditioning of the measured signals. Semiconductor gas sensors are typically electrical conductance or resistance sensors. At operating temperatures of 50° C. to 900° C., the electrical resistance of the semiconductor film changes upon contact with the gas to be detected. This reversible reaction makes possible the electronic detection of a gas. Typical detected gases may be NOₓ, CO, hydrocarbons, NH₃, O₃, and H₂O. Both the electrode structures and the gas-sensitive films of these sensors may typically be manufactured by thick-film and thin-film methods. Common materials for the active sensing elements may include semiconductor metal oxides such as SnO₂, WO₃, In₂O₃, Ga₂O₃, Cr₂₋ₓTiₓO₃, etc., and organic semiconductors such as polypyrrole, polyaniline, and phthalocyanine. The temperature may usually be employed to control the chemical reaction on the semiconductor films.

In these sensor arrangements, heaters and temperature sensor structures may usually be integrated on a suitable substrate platform. The gas sensitive metal oxide films may then be deposited on such platforms by thick-film and thin-film methods. Concentration of heat development by the heater may be concentrated on the sensitive surface with the aid of microstructured substrate platforms, while the surrounding region can remain cold. It may thus be advantageous for example to locate the detection electronics on the cold part of the substrate. Thermal decoupling may be effected for example with thin membranes of SiO₂/Si₃N₄ or hotplate structures.

Semiconductor gas sensors, for example metal oxide sensors, are based on the relatively simple functional principle that gas molecules are adsorbed at semiconductor surfaces and a certain portion of them may enter into a chemical bond with the semiconductor (i.e., chemisorption). Electrons may be localized and bound in the semiconductor-adsorbate complex or may be liberated by it. In the band model of the semiconductor, this corresponds to occupation of a surface state (with electrons or holes) that, in terms of its energetic position, is to be localized near the Fermi energy in the band gap.

Because the bound charge carriers are no longer available for current transport, this reoccupation of surface states may usually be detected with conductance sensors. An approximately equivalent option for measurement, so far not utilized in industry, comprises surface potential sensors (e.g., SGFET). A disadvantage of known arrangements of these sensors is that no design takes into account the planar manufacturing methods of conventional semiconductor fabrication.

The reoccupation of surface states results in a shift in the energy levels (i.e., position of the Fermi level). This in turn has retroactive effects on the surface states themselves, because the energy levels available are now differently distributed. This is why, for example, only a portion of the adsorbed gas molecules can go over to the chemisorbed state, because the occupation probability of the surface state is diminished along with the position of the Fermi level under chemisorption (self-blocking, “Weisz effect”).

Further, from the principles of semiconductor electronics it is known that the position of the Fermi level can be affected not just by the temperature and doping but also by electric fields. In gas sensors of the prior art, the position of the Fermi level may be determined through the temperature. In the gas sensor described and illustrated hereinafter the position of the Fermi level may be determined through electric fields. This is also known as “electroadsorption.” If, therefore, an electric field is impressed on a gas-sensitive semiconductor surface, the resulting shift in the Fermi level makes it possible to control the adsorption probability (chemisorption and physisorption) of gases on these surfaces. Gas sensors can therefore be made subject to electrical modulation of their sensitivity to various gases. In this way a parameter for gas sensors, which may be adjustable with no power consumption, becomes available such that the sensitivity modulation can be substantially expanded in terms of response time and selectivity through the heater temperature.

This electroadsorptive effect was postulated by Fedor Wolkenstein in 1957. Because it requires very high electric fields (close to the dielectric breakdown strength of air), however, it was not until 1968 that Hoenig and Lane experimentally confirmed the occurrence of the effect on a zinc oxide film placed in a flat-plate capacitor.

The potential inherent in this electrical sensitivity control of micro-structured gas sensors has been recognized in the prior art.

What is needed is a gas sensor whose design is oriented to the vertical electrical controllability of its sensitivity.

### SUMMARY OF THE INVENTION

An improved gas sensing technology through the use of the electroadsorptive effect with small and low-cost sensors can find use in, among other fields, production and process metrology, automobile manufacture, safety engineering, and climatic and environmental monitoring. The gas sensing technology described and illustrated herein makes it possible to implement semiconductor gas sensors with relatively better properties than prior art sensors. In particular, the gas sensor may have relatively enhanced selectivity and may be capable of functioning at lower operating temperatures, for example, significantly below 300° C.

The gas sensors described and illustrated herein function on the basis of gas-sensitive semiconductor materials. In contrast to known gas sensors made of semiconductor material in which a change in resistance in the resistor film is typically sensed by two electrodes, in the sensor there may be at least one electrode, and advantageously a plurality of electrodes inside the semiconductor body of the gas sensor for controlling the sensitivity. These further electrodes may be located under the resistor film and may be isolated from the resistor film by an insulator film. These further electrodes serve to produce an electric field acting on the semiconductor. The effect of the electric fields on the gas reaction of the sensitive film may be utilized. To this end, an electric field produced in the semiconductor body of the gas sensor via a field electrode may be effective up to the surface of the gas-sensitive film that faces toward the gas. That is, the films lying above the gate electrode do not screen the electric field. The Debye length L_{D} is a measure of the shielding length in semiconductors. The insulator film located between the resistor film and the further electrode(s) may have a maximum thickness that is less than or equal to approximately ten times the Debye length of the insulator material employed. The thickness may be chosen to be approximately less than or equal to three times the Debye length, and the thickness may further be chosen to be less than or equal to this Debye length.

The Debye length L_{D} may be defined as follows:

$${L}_{D} = \sqrt{\frac{{ɛɛ}_{0} kT}{{q}^{2} N}}$$

where
T is the temperature,
ε is the relative permittivity of the material,
ε₀ is the absolute permittivity,
k is the Boltzmann constant,
N is the charge-carrier concentration and
q is the elementary charge.

In the case of the frequently used gas-sensitive material SnO₂, for example, L_{D} is approximately 60 to 80 nm. The screening length in insulators may be relatively large. In an implementation in a component, however, impurities or defects and interfacial states may mean that the thickness of the insulator film does not exceed 300 nm, so that a sufficiently strong electric field can still be produced in the sensitive material of the gas sensor.

A plurality of further electrodes may be arranged in the semiconductor body, which makes it possible to offset or control the gradient in the surface potential variation due to the potential drop between the two electrodes of the resistor film.

The sensors may comprise semiconductor materials (such as for example the metal oxides SnO₂, WO₃, In₂O₃, Ga₂O₃, Cr₂₋ₓTiₓO_{3+z}, etc., or organic semiconductors) under which one or more further electrodes, called field electrodes may be deposited, these field electrodes being isolated by an insulator film.

The sensors may be distinguished by, among other things, the fact that they are structured on the substrates customary in microelectronics (such as silicon and silicon dioxide). What is more, it may also be possible to build on other substrates customary in gas sensing technology such as Al₂O₃ (including sapphire) in its usual forms.

In addition, between the control electrode and the semiconductor, an insulator material may be utilized that can withstand a high breakdown field strength and which does not screen electric fields.

Conventional gas sensors are operated at high temperatures of 250° C. to 900° C. to control absorption. In contrast, according to the sensors described and illustrated herein, the operating temperatures can be reduced to values below 200° C.

The sensor arrangement may yield an improved selectivity of the sensor for a target gas through utilization of the electroadsorptive effect.

The advantages of a low operating temperature may be made more evident by the possibility of integrating CMOS processing electronics on the sensor chip.

The sensor arrangements can be operated as an integrated sensor e.g., a dosimeter through utilization of the electroadsorptive effect.

A kinetic effect can also be introduced by modulating the gate voltage. Operation with a time-varying gate voltage periodically shifts the Fermi level in the metal oxide, that is, alteration of the electrochemical equilibrium under the effect of an external voltage on the field electrode. Periodic modulation of the gate voltage leads to an alternating variation in the resistance of the sensitive film. Through spectral analysis of this alternating variation in resistance, it may be possible to associate distinct frequency components with distinct gases and thus to achieve a gain in selectivity.

The possibility exists of electrical desorption of adsorbed gases, which can be driven away from the surface of the sensitive film by a strong field pulse. In this way an initial state of the sensors may be restored during continuous operation (i.e., baseline zeroing).

As an alternative to the finger electrode structure, a further possibility for bringing about the lateral distribution of the field under the sensitive film may be to provide the control electrode as a resistor, so that the potential drop along the resistor as current flows through it is parallel to the intended variation in surface potential of the sensitive film.

A combination of sensor temperature variation with field control may be possible.

Alternative operating modes of the controllable sensor in the linear/active region of the thin-film transistor may be possible.

Further alternatives include an adaptation of the finger electrode width to the grain size of the sensitive material, where each finger may drive one grain or a few grains, or that the spacing of finger electrodes may be in the range of the Debye length of the sensitive material or, alternatively, a finger electrode width that is less than or equal to the Debye length of the sensitive material.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 is a cross section of a gas-sensitive sensor and an accompanying graph illustrating the potential variation in the sensor;

FIG. 2 is a cross section of an embodiment of the gas sensor of FIG. 1 with a single field electrode located in the semiconductor body;

FIG. 3 is a cross section of an embodiment of the gas sensor of FIG. 1 with a plurality of field electrodes located in the semiconductor body; and

FIG. 4 is a cross section of a CMOS thin-film gas sensor with control electronics.

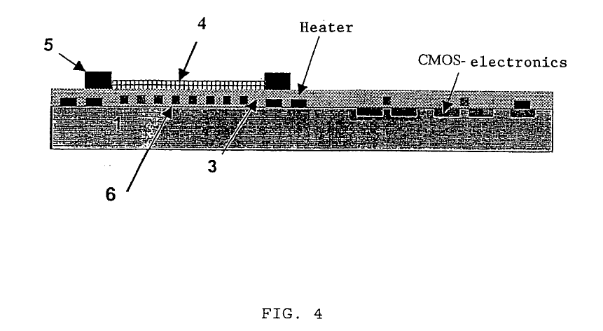

### DETAILED DESCRIPTION OF THE INVENTION

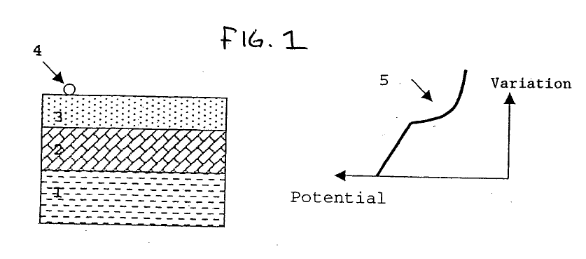

Referring to FIG. 1, a gas sensor includes an electrode 1 disposed under a gas-sensitive semiconductor film 3 with an insulator layer 2 in between. The aforementioned electroadsorptive effect may occur when the thickness of the gas-sensitive semiconductor film 3 is on the order of the Debye length L_{D}. In this way the surface absorption of gas molecules 4 can be controlled through an electric field. Further, the insulator layer 2 may be low in defects because these defects can substantially shorten the Debye length of the insulator layer 2 and thus interfere with penetration of the field to the gas-sensitive film 3. Examples of Debye lengths for SnO₂ are 60-80 nm where for insulators these lengths may be in the range below several micrometers.

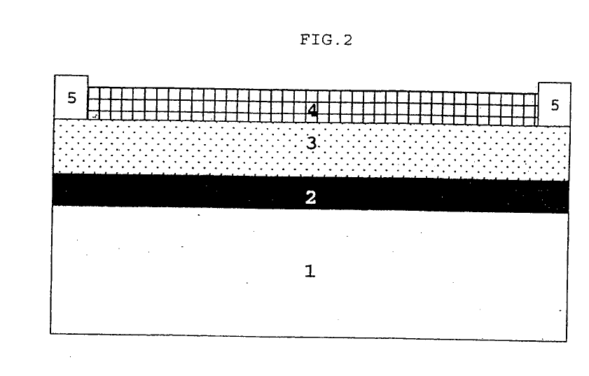

Referring to FIG. 2, the gas sensor includes a semiconductor substrate 1 on which is disposed a gas-sensitive film 4 with a thickness of for example 59 nm. The gas-sensitive film 4 may be contacted by two electrodes 5. The gas-sensitive film 4 can be made for example of SnO₂. The Debye length of this gas-sensitive film 4 may be approximately 80 nm. Below this gas-sensitive film 4 there may be disposed a field electrode 2 isolated by an insulator film 3.

The field electrode 2 may be provided as a plate electrode with its entire area located below the gas-sensitive film 4. The insulator film 3 may have a thickness of for example 200 nm. The Debye length of the gas-sensitive film 4 may be approximately 300 nm if silicon oxide is employed as the material for insulator film 3.

A measure for the screening length in semiconductors may be the Debye length LD, which is given by:

$${L}_{D} = \sqrt{\frac{{ɛɛ}_{0} kT}{{q}^{2} N}}$$

Thus, in the case of the frequently used gas-sensitive material SnO₂, the Debye length L_{D} may be approximately 60 to 80 nm. A thickness of approximately 200 nm for the insulator film 3 helps to ensure that a sufficiently strong electric field can be produced in the semiconductor via the field electrode 2.

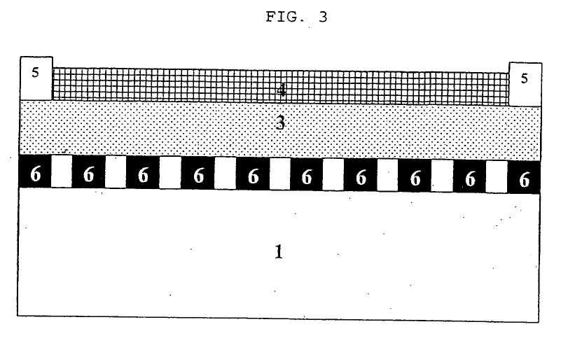

Referring to FIG. 3, in contrast to the gas sensor of FIG. 2, a plurality of microelectrodes 6 disposed under the gas-sensitive film 4, may be provided instead of a single field electrode 2. The use of such microelectrodes 6 spaced apart from one another has an advantage in that the gas-sensitive properties of a semiconductor film depend on the surface potential and thus the position of the Fermi level of the surface of gas-sensitive film 4 facing toward the gas. This effect may be utilized in the gas sensor illustrated in FIG. 3 for controlling the sensitivity and selectivity. To utilize this effect, it may be desirable to have a constant potential over the entire semiconductor surface of the gas-sensitive film 4.

If a voltage is applied to the electrodes 5 to read out the resistance of the gas-sensitive film 4 from the electrodes 5, a potential drop may appear between the two electrodes 5 and thus a gradient may appear in the surface potential. By applying various voltages to the microelectrodes 6, which are separate and electrically isolated from one another and located under the gas-sensitive film 4 inside the semiconductor substrate 1, it may be possible to compensate for this gradient and thus set a constant potential on the semiconductor surface or shift the potential in desired directions.

Referring to FIG. 5, the gas sensor may have a heater for the required working temperatures, which may be above 100° C. The chip in which the gas sensor is embodied may need to be heated to over 100° C., because absorbed water on the surface of the gas-sensitive film 4 may otherwise hinder the gas reaction. The resistive heater may be buried in the substrate 1 or structured on the surface. Because the sensitivity of semiconductor gas sensors may be a function of temperature, the heater can be controlled. To this end, the sensor chip may have a temperature sensor whose signal can be used to acquire the actual temperature.

The gas sensor arrangement may reduce the operating temperatures of conventional semiconductor gas sensors (250-900° C.) to values below 180° C. For this reason, integration of CMOS drives electronic circuits on the sensor chip may be possible.

Although the present invention has been shown and described with respect to several preferred embodiments thereof, various changes, omissions and additions to the form and detail thereof, may be made therein, without departing from the spirit and scope of the invention.

1. An integrated gas sensor, comprising a gas-sensitive semiconductor film in contact with at least one contact electrodes, a field electrode being disposed under the gas-sensitive semiconductor film, and an insulator layer disposed in between the field electrode and the gas-sensitive semiconductor film, where the insulator layer has a thickness that is less than or equal to approximately ten times the Debye length L_{D} of the gas-sensitive semiconductor film and corresponding to the insulator later, where the Debye length L_{D} is given by:
$${L}_{D} = \sqrt{\frac{{ɛɛ}_{0} kT}{{q}^{2} N}}$$
where T is the temperature, ε is the relative permittivity of the material of the gas-sensitive semiconductor film, ε₀ is the absolute permittivity, k is the Boltzmann constant, N is the charge-carrier concentration and q is the elementary charge.

2. The integrated gas sensor of claim 1, where the insulator layer has a thickness that is less than or equal to approximately three times the Debye length L_{D} of the gas-sensitive semiconductor film and corresponding to the insulator layer.

3. The integrated gas sensor of claim 1, where the insulator layer has a thickness that is less than or equal to approximately the Debye length L_{D} of the gas-sensitive semiconductor film and corresponding to the insulator layer.

4. The integrated gas sensor of claim 1, where the field electrode comprises a plurality of microstructured field electrodes.

5. The integrated gas sensor of claim 4, where each one of the microstructured field electrodes is individually drivable.

6. The integrated gas sensor of claim 1, further comprising at least one heater electrode, the heater electrode being integrated with the gas sensor.

7. The integrated gas sensor of claim 1, further comprising driver electronics, the driver electronics being integrated with the gas sensor.

8. The integrated gas sensor of claim 7, where the driver electronics comprise a temperature control.

9. The integrated gas sensor of claim 1, where the thickness of the gas-sensitive semiconductor film is at most approximately one-hundred times greater than a Debye length of the gas-sensitive film.

10. The integrated gas sensor of claim 4, where the spacing between the plurality of the microstructured electrodes is on the order of a grain size of the gas-sensitive semiconductor film.

11. The integrated gas sensor of claim 1, where the gas-sensitive semiconductor film comprises SnO₂.

12. A gas sensor, comprising:
a gas-sensitive semiconductor film;
at least one contact electrode in electrical contact with the gas-sensitive film;
an insulator layer disposed next to the gas-sensitive semiconductor film; and
at least one field electrode disposed next to the insulator layer;
where the insulator layer has a thickness that is less than about ten times a Debye length L_{D} of the gas-sensitive semiconductor film.

13. The gas sensor of claim 12, further comprising a semiconductor substrate disposed next to the at least one field electrode.

14. The gas sensor of claim 12, where the insulator layer has a thickness that is less than about three times the Debye length L_{D} of the gas-sensitive semiconductor film.

15. The gas sensor of claim 12, where the insulator layer has a thickness that is less than the Debye length L_{D} of the gas-sensitive semiconductor film.

16. The gas sensor of claim 12, where the insulator layer has a thickness that is approximately equal to the Debye length L_{D} of the gas-sensitive semiconductor film.

17. The gas sensor of claim 12, where the at least one field electrode comprises a plurality of field electrodes.
